(19) United States
(12) Patent Application Publication
(10) Pub. No.: US 2022/0378104 A1
(43) Pub. Date: Dec. 1, 2022

(54) ATOMIZER AND ELECTRONIC CIGARETTE COMRPISING THE SAME

(71) Applicant: Shenzhen Eigate Technology Co., Ltd., Shenzhen (CN)

(72) Inventor: Tuanfang LIU, Shenzhen (CN)

(21) Appl. No.: 17/524,693

(22) Filed: Nov. 11, 2021

(30) Foreign Application Priority Data
May 28, 2021 (CN) 202110606466.6
May 28, 2021 (CN) 202121182455.1

(51) Int. Cl. A24F 40/485; A24F 40/10; A24F 40/42; A24F 40/46; H05B 1/00

(52) U.S. Cl. CPC A24F 40/485; A24F 40/10; A24F 40/42; A24F 40/46; H05B 1/00

(57) ABSTRACT

An atomizer includes an e-liquid storage tube, an atomizing tube, and a cylindrical ring. The atomizing tube includes an air supplementary inlet and an e-liquid inlet. The atomizing tube is disposed in the e-liquid storage tube. The cylindrical ring is disposed in the atomizing tube and is adjacent to the air supplementary inlet; and an air passage is defined by the inner wall of the atomizing tube and the outer wall of the cylindrical ring.

### CROSS-REFERENCE TO RELATED APPLICATIONS

Pursuant to 35 U.S.C. § 119 and the Paris Convention Treaty, this application claims foreign priority to Chinese Patent Application No. 202110606466.6 filed May 28, 2021, and to Chinese Patent Application No. 202121182455.1 filed May 28, 2021. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND

The disclosure relates to an atomizer and an electronic cigarette comprising the same.

After atomization, a negative pressure is generated and maintained in the e-liquid storage tubes of conventional atomizers. If no air is supplemented to the e-liquid storage tubes, the e-liquid cannot flow to the e-liquid absorbent member, which may burn out the heating element. Some atomizers include an air inlet disposed under the e-liquid inlet, so that the e-liquid easily flows through the air inlet out of the atomizers, leading to short circuit.

### SUMMARY

The first objective of the disclosure is to provide an atomizer; the atomizer comprises an e-liquid storage tube, an atomizing tube, and a cylindrical ring; the atomizing tube comprises an air supplementary inlet and an e-liquid inlet; the atomizing tube is disposed in the e-liquid storage tube; the cylindrical ring is disposed in the atomizing tube and is adjacent to the air supplementary inlet; an air passage is defined by an inner wall of the atomizing tube and an outer wall of the cylindrical ring. In this way, the e-liquid flows through the e-liquid inlet into the heating element; external air flows through the air supplementary inlet and enters the e-liquid storage tube via the air passage to balance the pressure, thus increasing the velocity of the e-liquid flowing into the e-liquid storage tube.

In a class of this embodiment, the e-liquid inlet is disposed below the air supplementary inlet; and/or a heating element is secured within the atomizing tube and is next to the e-liquid inlet; and/or the heating element is in the form of a hollow tube; one end of the cylindrical ring is connected to one end of the heating element; the e-liquid flows through the e-liquid inlet and bubbles may produce; the bubbles are suspended in the e-liquid and can be discharged from the air supplementary inlet.

In a class of this embodiment, the air supplementary inlet is in the shape of a circle, a triangle, a quadrilateral, or a polygon.

In a class of this embodiment, the atomizing tube comprises at least one e-liquid inlet; the e-liquid inlet is in the shape of a circle, a triangle, a quadrilateral, or a polygon.

In a class of this embodiment, the atomizing tube comprises a side wall and two e-liquid inlets disposed on the side wall, and a connection line of the two e-liquid inlets is parallel to an axial line of the atomizing tube.

In a class of this embodiment, the air supplementary inlet has a diameter of 0.5-1 mm and communicates with the atomizing tube.

In a class of this embodiment, the heating element comprises a metal body, a ceramic body, a piece of cotton wrapped about a metal body, a piece of cotton wrapped about a ceramic body, a piece of cotton wrapped in a metal body, or a piece of cotton wrapped in a ceramic body.

In a class of this embodiment, the cylindrical ring is hollow and comprises silicone, metal, plastic, rubber, or ceramic.

In a class of this embodiment, the atomizer further comprises a mouthpiece disposed in a top opening of the e-liquid storage tube and connected to a top end of the atomizing tube.

In a class of this embodiment, the atomizing tube and the mouthpiece separately comprise ceramic, quartz, glass, crystal, jade, agate, or metal.

In a class of this embodiment, the atomizer further comprises a base; a base portion of the atomizing tube and a lower end of the e-liquid storage tube are separately disposed on the base.

In a class of this embodiment, the base comprises a plurality of air inlets.

In a class of this embodiment, when a user inhales on the mouthpiece, external air flows through the plurality of air inlets into the atomizing tube, causing the heating element to atomize the e-liquid; the smoke produced flows through the mouthpiece and is inhaled by the user.

The second objective of the disclosure is to provide an electronic cigarette; the electronic cigarette comprises the atomizer and a battery assembly; the atomizer is formed integrally with, fixedly connected to, or detachably connected to the battery assembly.

### BRIEF DESCRIPTION OF THE DRAWINGS

FIG. 1 is an exploded view of an atomizer according to one embodiment of the disclosure;

FIG. 2 is a perspective view of an atomizer according to one embodiment of the disclosure;

FIG. 3 is a cross-sectional view of an atomizer according to one embodiment of the disclosure;

FIG. 4 is a cross-sectional view including arrows showing the direction of airflow in an atomizer according to one embodiment of the disclosure;

FIG. 5 is a cross-sectional view including arrows showing the direction of supply air in an atomizer according to one embodiment of the disclosure;

In the drawings, the following reference numbers are used: 1. Mouthpiece; 2. Gasket; 3. Connector; 4. Seal ring; 5. E-liquid storage tube; 6. Atomizing tube; 7. Cylindrical ring; 8. Heating element; 9. Silicone ring; 10. Decorative ring; 11. Base; 12. Insulating ring; 13. Joint; 6-1. Air supplementary inlet; and 6-2. E-liquid inlet.

### DETAILED DESCRIPTION

To further illustrate the disclosure, embodiments detailing an atomizer and an electronic cigarette comprising the same are described below. It should be noted that the following embodiments are intended to describe and not to limit the disclosure.

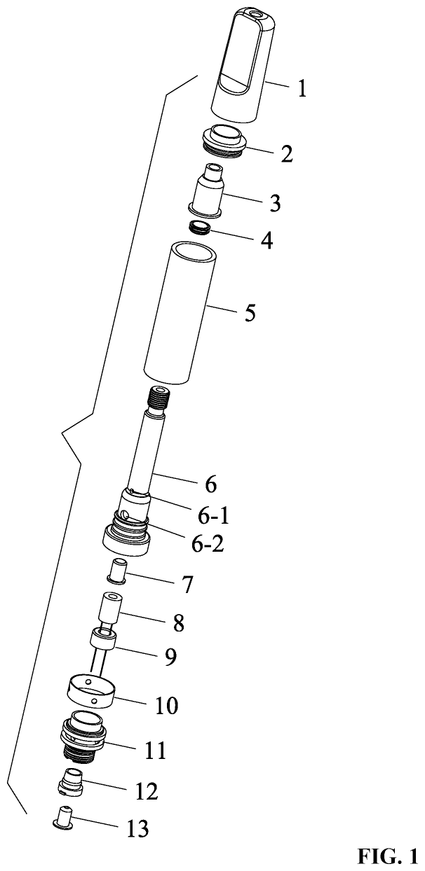

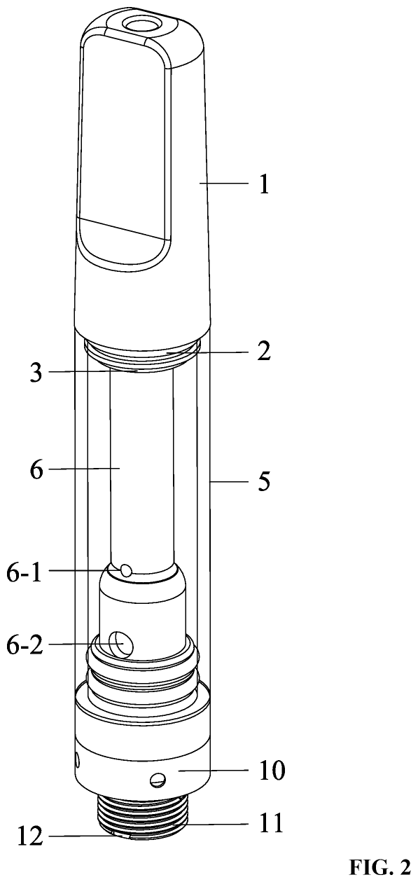

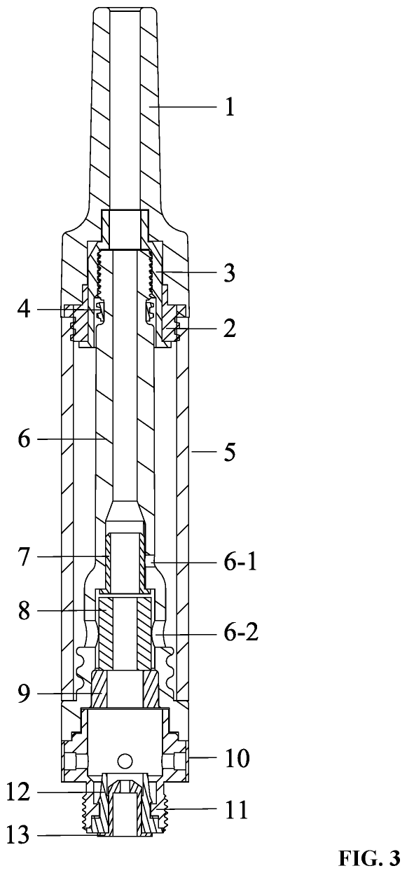

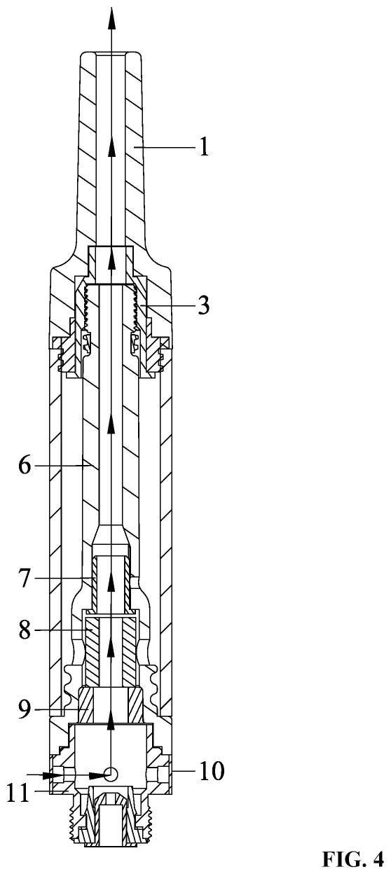

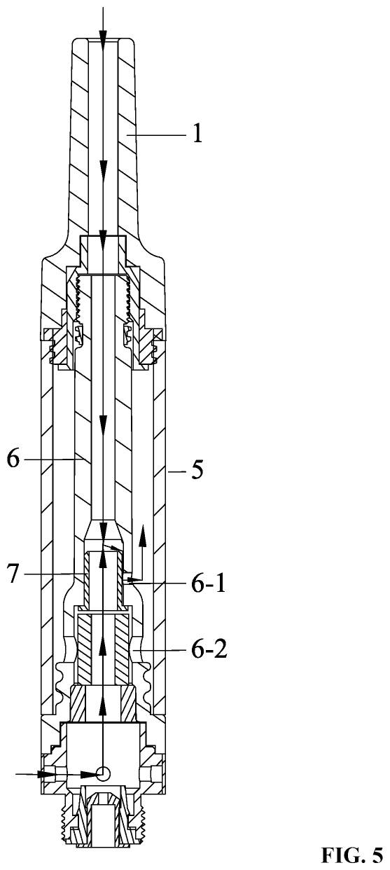

Referring to FIGS. 1-5, an electronic cigarette comprises an atomizer and a battery assembly. The atomizer comprises a mouthpiece 1, a gasket 2, a connector 3, a seal ring 4, an e-liquid storage tube 5, an atomizing tube 6, a cylindrical ring 7, a heating element 8, a silicone ring 9, a decorative ring 10, a base 11, an insulating ring 12, and a joint 13. The atomizing tube 6 comprises an air supplementary inlet 6-1 and an e-liquid inlet 6-2 disposed below the air supplementary inlet 6-1. The cylindrical ring 7 is disposed in the atomizing tube 6 and is adjacent to the air supplementary inlet 6-1 to prevent e-liquid from flowing into the air supplementary inlet 6-1. An air passage is defined by the inner wall of the atomizing tube 6 and the outer wall of the cylindrical ring 7. A piece of nonwoven cotton is wrapped around the heating element 8 to absorb the e-liquid. The heating element 8 is disposed in the atomizing tube 6 and under the cylindrical ring 7 to abut against an edge of the e-liquid inlet 6-2. The silicone ring 9 is disposed in the atomizing tube 6 to seal the base portion of the atomizing tube 6 and is disposed under the heating element 8 to support the heating element 8. The decorative ring 10 is disposed around the lower portion of the base 11. The base 11 comprises a plurality of air inlets and the decorative ring 10 comprises a plurality of first through holes respectively communicating with the plurality of air inlets. The base portion of the atomizing tube 6 is disposed around an upper portion of the base. The heating element 8 comprises a positive pin and a negative pin. The insulating ring 12 is disposed in a bottom portion of the base 11 to isolate the positive pin and the negative pin. The joint 13 is disposed in the insulating ring 12 so as to be in contact with the two pins and limit changes in the position of the two pins. A lower end of the e-liquid storage tube 5 is disposed around the base portion of the atomizing tube 6 to ensure that the atomizing tube 6 is disposed in the e-liquid storage tube 5. The e-liquid storage tube 5 is configured to store the e-liquid. The e-liquid flows through the e-liquid inlet 6-2 into the heating element 8. The gasket 2 is disposed on the connector 3 and the connector 3 is disposed on a top end of the atomizing tube 6. The mouthpiece 1 is disposed on the gasket 2 so that an upper portion of the connector 3 is disposed in the mouthpiece 1 as well. The seal ring 4 is disposed around the top end of the atomizing tube 6 to seal a gap between the top end of the atomizing tube 6 and an inner wall of the connector 3. The gasket 2 is disposed in the top opening of the e-liquid storage tube 5 and the connector 3 is disposed on the top end of the atomizing tube 6.

In certain embodiments, the mouthpiece 1, the atomizing tube 6, and the heating element 8 separately comprise quartz, crystal, agate, jade, or glass. The heating element 8 is in the shape of a cylinder, a square, a hemisphere, a cone, or a polygon. The heating element 8 further comprises a second through hole in the shape of a circle, an ellipse, a triangle, a quadrilateral, a polygon, or a mesh. The heating element 8 further comprises at least two heating wires connected in parallel or series and disposed on a bottom surface of the heating element 8 or around a peripheral wall of the heating element 8. The at least two heating wires comprise alloy metal and is wounded in the shape of a flat screen, a mesh, or a grid.

The following advantages are associated with the atomizer and the electronic cigarette of the disclosure:

1. The atomizer comprises the atomizing tube provided with the e-liquid inlet and the air supplementary inlet; external air flows through the air supplementary inlet into the atomizer to provide sufficient pressure for smooth flow;

2. The e-liquid inlet is disposed below the air supplementary inlet and the cylindrical ring is disposed adjacent to the air supplementary inlet to form the air passage; the air passage allows only air to flow through while preventing the passage of the e-liquid; and

3. Both the atomizing tube and the mouthpiece separately comprise ceramic; ceramic material is not available to react with the smoke, which prevents the production of strange smell that may affect the taste of the smoke.

It will be obvious to those skilled in the art that changes and modifications may be made, and therefore, the aim in the appended claims is to cover all such changes and modifications.

The invention claimed is:

1. An atomizer, comprising an e-liquid storage tube, an atomizing tube, and a cylindrical ring; wherein the atomizing tube comprises an air supplementary inlet and an e-liquid inlet; the atomizing tube is disposed in the e-liquid storage tube; the cylindrical ring is disposed in the atomizing tube and is adjacent to the air supplementary inlet; and an air passage is defined by an inner wall of the atomizing tube and an outer wall of the cylindrical ring.

2. The atomizer of claim 1, wherein the e-liquid inlet is disposed below the air supplementary inlet; and/or a heating element is secured within the atomizing tube and is next to the e-liquid inlet; and/or the heating element is in the form of a hollow tube; and one end of the cylindrical ring is connected to one end of the heating element.

3. The atomizer of claim 1, wherein the air supplementary inlet is in the shape of a circle, a triangle, a quadrilateral, or a polygon.

4. The atomizer of claim 1, wherein the atomizing tube comprises at least one e-liquid inlet; the e-liquid inlet is in the shape of a circle, a triangle, a quadrilateral, or a polygon.

5. The atomizer of claim 4, wherein the atomizing tube comprises a side wall and two e-liquid inlets disposed on the side wall, and a connection line of the two e-liquid inlets is parallel to an axial line of the atomizing tube.

6. The atomizer of claim 1, wherein the air supplementary inlet has a diameter of 0.5-1 mm and communicates with the atomizing tube.

7. The atomizer of claim 2, wherein the heating element comprises a metal body, a ceramic body, a piece of cotton wrapped about a metal body, a piece of cotton wrapped about a ceramic body, a piece of cotton wrapped in a metal body, or a piece of cotton wrapped in a ceramic body.

8. The atomizer of claim 1, wherein the cylindrical ring is hollow and comprises silicone, metal, plastic, rubber, or ceramic.

9. The atomizer of claim 1, wherein the atomizer further comprises a mouthpiece disposed in a top opening of the e-liquid storage tube and connected to a top end of the atomizing tube.

10. The atomizer of claim 9, wherein the atomizing tube and the mouthpiece separately comprise ceramic, quartz, glass, crystal, jade, agate, or metal.

11. The atomizer of claim 1, wherein the atomizer further comprises a base; a base portion of the atomizing tube and a lower end of the e-liquid storage tube are separately disposed on the base.

12. The atomizer of claim 11, wherein the base comprises a plurality of air inlets.

13. An electronic cigarette, comprising the atomizer of claim 1 and a battery assembly.
